(19) United States
(12) Patent Application Publication
(10) Pub. No.: US 2026/0368274 A1
(43) Pub. Date: Nov. 19, 2026

(54) METHOD AND DEVICE FOR LOCALIZING AN ERROR IN THE DETERMINATION OF MATRIX-VECTOR PRODUCTS

(71) Applicant: Robert Bosch GmbH, Stuttgart (DE)

(72) Inventors: Tobias Kirchner, Ludwigsburg (DE); Nico Bannow, Stuttgart (DE); Stefan Metzlaff, Renningen (DE)

(21) Appl. No.: 19/681,217

(22) Filed: May 19, 2026

(30) Foreign Application Priority Data
May 19, 2025 (DE) 10 2025 119 233.2

(51) Int. Cl. G06F 17/16; G06F 7/544

(52) U.S. Cl. CPC G06F 17/16; G06F 7/5443

(57) ABSTRACT

A device and a computer-implemented method for localizing an error in the determination of matrix-vector products. The matrix-vector products include scalar products. A first checksum for verifying a first sum is determined for each matrix-vector product. The summands of the relevant first sum are the scalar products of the relevant matrix-vector product. A second checksum for verifying a second sum is determined. The summands of the second sum are one scalar product for each matrix-vector product. The error is localized in one of the scalar products depending on the sums and the checksums.

### FIELD

The present disclosure relates to a method and a device for localizing an error in the determination of matrix-vector products.

### SUMMARY

According to an example embodiment, a computer-implemented method is provided for localizing an error in the determination of matrix-vector products, for example at least partially using in-memory computing, wherein the matrix-vector products comprise scalar products, wherein for each matrix-vector product, for example at least partially using in-memory computing, a first checksum is determined to verify a first sum, wherein the summands of the relevant first sum are the scalar products of the relevant matrix-vector product, wherein, for example at least partially using in-memory computing, a second checksum is determined to verify a second sum, wherein the summands of the second sum are one scalar product for each matrix-vector product, wherein the error is localized in one of the scalar products depending on the sums and the checksums.

It may be provided that the correction of the error in the localized scalar product is determined depending on the difference between the first sum and the first checksum or depending on the difference between the second sum and the second checksum.

It may be provided that a plurality of second sums are formed, for example at least partially using in-memory computing, wherein the summands of the second sums differ from each other by at least one summand, wherein a second checksum is determined for each second sum, for example at least partially using in-memory computing, to verify the relevant second sum, wherein, a third checksum is determined, for example at least partially using in-memory computing, to verify a third sum, wherein the summands of the third sum are the first checksums, or the second checksums, or the first checksums and the second checksums, and wherein it is checked whether the third sum and the third checksum match, wherein the correction of the error in the localized scalar product is determined depending on the difference if the third sum and the third checksum match, and otherwise no correction of the error in the localized scalar product is made depending on the difference.

It may be provided that the relevant matrix-vector product is determined, for example at least partially using in-memory computing, depending on the values of the elements of a relevant matrix, wherein the matrix-vector products are determined depending on the values of the elements of a vector.

It may be provided that the values of the elements of the relevant matrix are each assigned to one of the scalar products, wherein, for each element of the vector, the sum of the values of the elements of the relevant matrix, which are multiplied in the scalar products by the value of the element of the vector, is determined, and the product of the sum of the values is determined with the value of the element of the vector, wherein the sum of the products forms the first checksum.

It may be provided that, for each element of the vector, the sum of the values of the elements of the matrices, which, in the scalar products, form the summands of the second sum and which are multiplied by the value of the element of the vector, is determined, and the product of the sum of the values is determined with the value of the element, wherein the sum of the products forms the second checksum.

It may be provided that the values of the elements of the matrices and the sum of the values of the elements are each stored as the content of at least one memory cell of a memory according to a mapping rule, wherein, for each element of the vector, the mapping rule assigns, to the element of the vector, the memory cells whose content is to be multiplied by the element of the vector, wherein, for each scalar product, the mapping rule assigns, to the scalar product, the memory cells whose content is used to determine the scalar product, wherein, for each checksum, the mapping rule assigns, to the checksum, the memory cells whose content is used to determine the checksum.

It may be provided that the values from the contents of the memory cells are read out to calculate the scalar products and checksums according to the mapping rule.

It may be provided that the values of the elements of the matrices are binary values and the memory cells each store one of the binary values, or that the values of the elements of the matrices are multi-bit values and the memory cells each store one bit or a plurality of bits of a multi-bit value according to the mapping rule, wherein the multi-bit values are read out from the memory cells according to the mapping rule.

It may be provided that the values are stored in analog memory cells, or that the values are stored in digital memory cells.

According to an example embodiment, a device is provided for localizing an error in the determination of matrix-vector products, for example at least partially using in-memory computing, for example to correct the error, wherein the device is configured to execute the method of the present disclosure.

It may be provided that the device comprises a memory with analog memory cells or with digital memory cells.

It may be provided that the device comprises, for each scalar product, an adder or at least one output to an adder which is configured to determine the relevant scalar product, wherein the device comprises, for each checksum, an adder or at least an output to an adder configured to determine the relevant checksum.

It may be provided that the device comprises at least one processor, wherein the device is configured to determine a portion of the scalar products and/or the summands, for example using in-memory computing, in the memory, and another portion of the scalar products and/or the summands using the at least one processor, and to determine the sums and/or checksums using the at least one processor or the adders, or partially using the at least one processor and partially using the adders.

A computer program, wherein the computer program comprises computer-readable instructions, during the execution of which by a computer the computer executes the method of the present disclosure.

Further exemplary embodiments can be found in the following description and the figures.

### BRIEF DESCRIPTION OF THE DRAWINGS

FIG. 1 schematically shows a device for localizing an error in the determination of matrix-vector products, according to an example embodiment.

FIG. 2 is a flowchart of a method for localizing the error, according to an example embodiment.

FIG. 3 shows a first exemplary mapping rule, according to an example embodiment.

FIG. 4 shows a second exemplary mapping rule, according to an example embodiment.

FIG. 5 shows a third exemplary mapping rule, according to an example embodiment.

### DETAILED DESCRIPTION OF EXAMPLE EMBODIMENTS

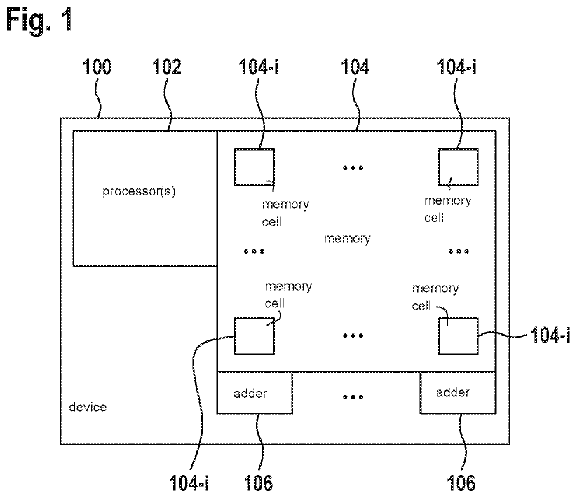

FIG. 1 schematically illustrates a device 100 for localizing an error in the determination of matrix-vector products, for example at least partially using in-memory computing.

The device 100 comprises at least one processor 102. The device 100 comprises at least one memory 104.

The at least one memory 104 comprises memory cells 104-i.

The memory cells 104-i may be analog. This means that the memory 104 comprises analog memory cells. The memory cells 104-i may be digital. This means that the memory 104 comprises digital memory cells. It may be provided that the memory 104 comprises analog and digital memory cells.

The device 100 is configured to determine a method for localizing an error in the determination of matrix-vector products, for example at least partially using in-memory computing, by means of checksums. The device 100 is optionally configured to correct the error using a checksum. In the case of in-memory computing, the data processed in the in-memory computing, for example, are processed in the memory 104.

Matrix-vector products comprise scalar products. In the example, the relevant scalar product is determined using an adder 106. In the example, the device 100 comprises one adder 106 for each scalar product.

It may be provided that the device 100 is configured to determine a portion of the scalar products, for example using in-memory computing in the memory 104. It may be provided that the device 100 is configured to determine a portion of the scalar products using the at least one processor 102.

The device 100 is configured to determine a first checksum for verifying a first sum. The summands of the relevant first sum are the scalar products of the relevant matrix-vector product.

The device 100 is configured to determine a second checksum for verifying a second sum. The summands of the second sum are each a scalar product of each matrix-vector product.

The device 100 for correcting the error is configured to determine a third checksum for verifying a third sum. The summands of the third sum are the first checksums, or the second checksums, or the first checksums and the second checksums.

In the example, the relevant checksum is determined using an adder 106.

In the example, the device 100 comprises one adder 106 per checksum.

It may be provided that the device 100 is configured to determine a portion of the relevant checksum, for example using in-memory computing in the memory 104. It may be provided that the device 100 is configured to determine a portion of the relevant checksum using the at least one processor 102. It may be provided that the device 100 is configured to determine the relevant checksum using in-memory computing.

It may be provided that at least one of the adders 106 is arranged outside the device 100, wherein the device 100 comprises at least one output to the at least one adder 106 and one input for the result from the adder 106.

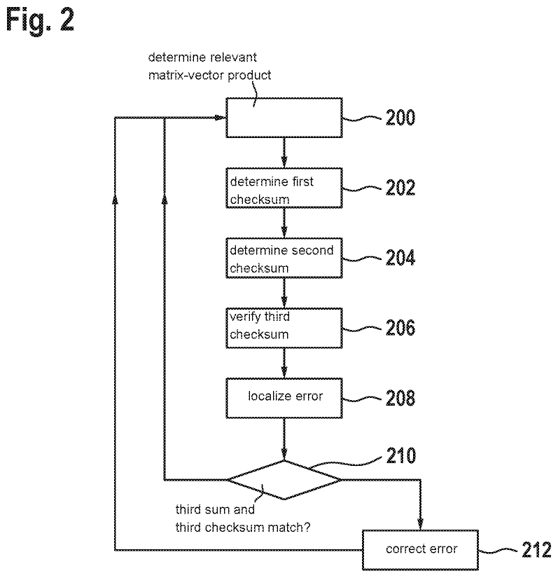

FIG. 2 shows a flowchart of a method for localizing the error.

The method involves determining matrix-vector products with the same vector. The method involves determining, for each of a plurality of matrices, a matrix-vector product of the relevant matrix with the vector, for example at least partially using in-memory computing.

The method comprises a step 200.

In the step 200, the relevant matrix-vector product is determined depending on the values of the elements of the relevant matrix and depending on the values of the elements of the vector.

The values of the elements of the relevant matrix are each assigned to one of the scalar products.

For each element of the vector, the sum of the values of the elements of the relevant matrix, which are multiplied by the value of the element of the vector in the scalar products, is determined. For each element of the vector, the product of the sum of the values is determined with the value of the element of the vector.

In the example, the values of the elements of the matrices and the sum of the values of the elements are each stored as the content of at least one memory cell of the at least one memory 104 according to a mapping rule.

For each element of the vector, the mapping rule assigns, to the element of the vector, the memory cells 104-i whose contents are to be multiplied by the element of the vector.

For each scalar product, the mapping rule assigns, to the scalar product, the memory cells 104-i whose contents are used to determine the scalar product.

In the example, the values are read out from the contents of the memory cells 104-i to calculate the scalar products according to the mapping rule.

The values are stored, for example, in the analog memory cells. The values are stored, for example, in the digital memory cells. It may be provided that one portion of the values is stored in an analog manner, i.e., in at least one analog memory cell for each value, and another portion of the values is stored digitally, i.e., in at least one digital memory cell for each value.

The values of the elements of the matrices are, for example, binary values, wherein the memory cells 104-i each store one of the binary values.

The values of the elements of the matrices are, for example, multi-bit values, wherein the memory cells 104-i each store one bit or a plurality of bits of a multi-bit value according to the mapping rule. The multi-bit values are read out from the memory cells 104-i according to the mapping rule.

The method comprises a step 202.

In the step 202, a first checksum is determined for each matrix-vector product to verify a first sum, for example at least partially using in-memory computing.

The summands of the relevant first sum are the scalar products of the relevant matrix-vector product.

This means that, for each matrix, the sum of the products, determined for the same element of the vector, of the value of the element of the matrix, forms the first checksum with the element of the vector.

In the example, the mapping rule assigns, to the first checksum, the memory cells whose contents are to be used to determine the first checksum.

In the example, the values from the contents of the memory cells for calculating the first checksums are read out according to the mapping rule.

The method comprises a step 204.

In the step 204, a second checksum is determined, for example at least partially using in-memory computing, to verify a second sum.

The summands of the second sum are each a scalar product of each matrix-vector product.

For each element of the vector, for example, the sum of the values of the elements of the matrices, which, in the scalar products, form the summands of the second sum and which are multiplied by the value of the element of the vector, is determined. Then the product of the sum of the values is determined with the value of the element. The sum of the relevant products determined for the elements of the vector forms the second checksum.

In the example, the mapping rule assigns, to the second checksum, the memory cells whose contents are to be used to determine the second checksum.

In the example, the values from the contents of the memory cells for calculating the second checksums are read out according to the mapping rule.

Optionally, it may be provided that the step 204, for the formation of multiple second sums, is executed in iterations.

In the iterations, the summands of the second sums differ from each other by at least one summand.

In the iterations, a second checksum is determined for each second sum to verify the relevant second sum, for example at least partially using in-memory computing.

The method optionally comprises a step 206.

In the step 206, a third checksum for verifying a third sum is determined, for example at least partially using in-memory computing.

The summands of the third sum are, for example, the first checksums.

The summands of the third sum are, for example, the second checksums.

The summands of the third sum are, for example, the first checksums and the second checksums.

In the example, the mapping rule assigns, to the third checksum, the memory cells whose contents are to be used to determine the third checksum.

In the example, the values from the contents of the memory cells for calculating the third checksums are read out according to the mapping rule.

The method comprises a step 208.

In the step 208, the error is localized in one of the scalar products depending on the sums and the first checksums and the second checksums.

The flowchart shown in FIG. 2 comprises some optional steps for correcting the error.

In an optional step 210, it is checked whether the third sum and the third checksum match.

If the third sum and the third checksum match, a step 212 is executed to correct the error depending on a difference between the first sum and the first checksum or depending on a difference between the second sum and the second checksum.

Otherwise, in the example, the error in the localized scalar product is not corrected depending on the difference. It may be provided that the method for recalculating the matrix-vector product continues with step 200.

In the step 212, the error in the localized scalar product is corrected depending on the difference between the first sum and the first checksum if there is a difference between the first sum and the first checksum. In the step 212, the error in the localized scalar product is determined depending on the difference between the second sum and the second checksum if there is a difference between the second sum and the second checksum.

In the example, the method continues after step 212 to calculate a further matrix-vector product with step 200.

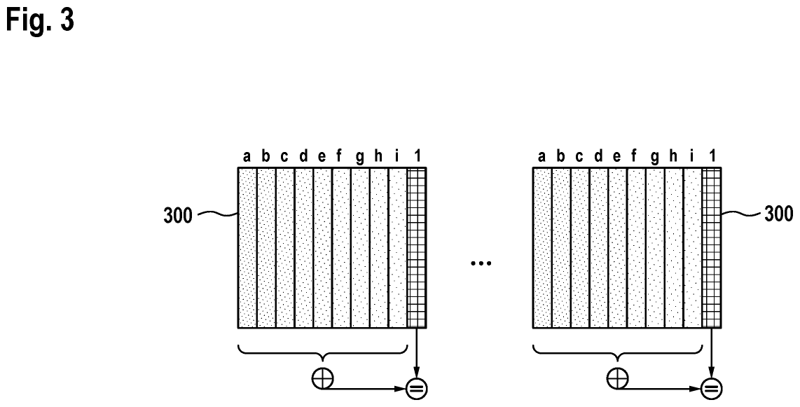

FIG. 3 shows an exemplary first mapping rule. The first mapping rule is shown for columns of exemplary matrices 300 and one check column 1 per matrix 300. The columns of the relevant matrix 300 are labeled, from left to right in FIG. 3, with a, b, c, d, e, f, g, h, i.

The check column 1 of the relevant matrix 300 comprises, for each row of check column 1, a sum of the values of the elements of matrix 300 from the row.

This means that, in the error-free case, the sum of the scalar products that the vector forms with the values from the relevant column of the relevant matrix 300 must be the scalar product that the vector forms with the sums from the check column 1 of the relevant matrix 300.

The first mapping rule allows error detection and localization. If the sum of the scalar products determined for a matrix 300 deviates from the scalar product determined for the check column 1 of the same matrix 300, assuming that the scalar product for the check column 1 of this matrix 300 is correct, an error in a scalar product of this matrix 300 is detected and localized.

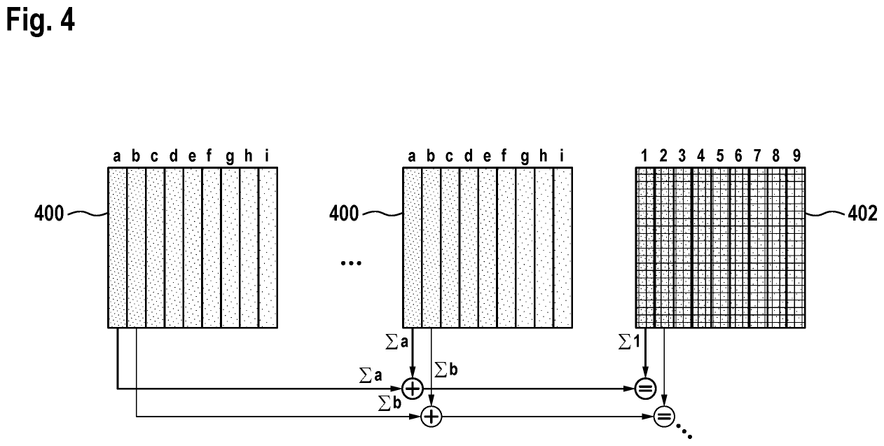

FIG. 4 shows an exemplary second mapping rule. The second mapping rule is shown for columns of exemplary matrices 400 and a check matrix 402. The columns of the relevant matrix 400 are labeled, from left to right in FIG. 4, with a, b, c, d, e, f, g, h, i. The check matrix 402 comprises check columns for the columns from the matrices 400, which columns are labeled, from left to right in FIG. 4, with 1, 2, 3, 4, 5, 6, 7, 8, 9.

In the example, the second mapping rule s-p assigns a check column p from the check matrix 402 to each of the columns s from the relevant matrix 400. FIG. 4 shows the following second mapping rule s-p:
1-a, 2-b, 3-c, 4-d, 5-e, 6-f, 7-g, 8-h, 9-i.

The check column p for the columns s comprises, for each row z of the check column p, a sum of the values of the elements of the matrices 400 from the row z of the relevant matrix 400 and the column a.

This means that, in the error-free case, the sum of the scalar products that the vector forms for each column s with the values from the column s of the relevant matrix 400 must be the scalar product that the vector forms with the sums from the check column p.

The second mapping rule allows error detection and localization. If the sum of the scalar products determined for columns s of the matrices 400 deviates from the scalar product determined for the check column p for the columns s, assuming that the scalar product for the check column p is correct, an error in a scalar product in at least one of the check columns p is detected and localized.

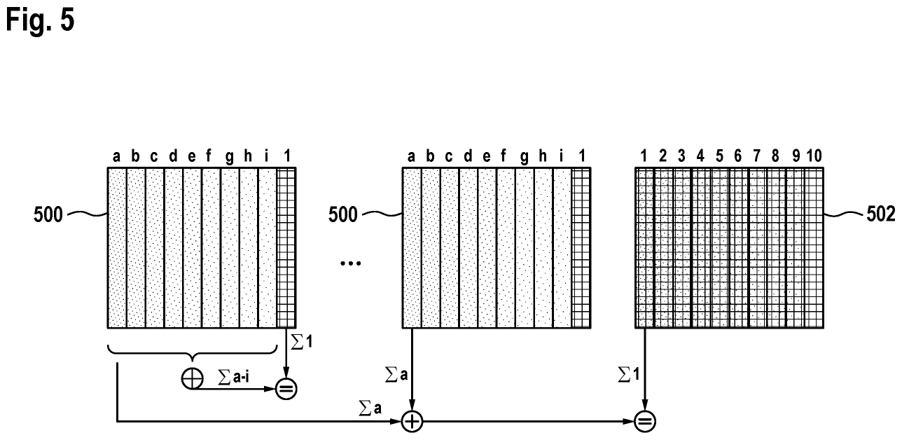

FIG. 5 shows an exemplary third mapping rule. The third mapping rule is shown for columns of exemplary matrices 500, one check column 1 per matrix 500 and one check matrix 502. The columns of the relevant matrix 500 are labeled, from left to right in FIG. 5, with a, b, c, d, e, f, g, h, i. The check matrix 502 comprises check columns for the columns from the matrices 500, which columns are labeled, from left to right in FIG. 4, with 1, 2, 3, 4, 5, 6, 7, 8, 9. The check matrix 502 comprises a check column for the check columns 1 from the matrices 500, which is labeled 10 in FIG. 5.

The check column 1 of the relevant matrix 500 comprises, for each row of the check column 1, a sum of the values of the elements of the matrix 500 from the row.

This means that, in the error-free case, the sum of the scalar products that the vector forms with the values from the relevant column of the relevant matrix 500 must be the scalar product that the vector forms with the sums from the check column 1 of the relevant matrix 500.

In the example, the third mapping rule s-p assigns a check column p from the check matrix 502 to each of the columns s from the relevant matrix 500. FIG. 5 shows the following second mapping rule s-p:
1-a, 2-b, 3-c, 4-d, 5-e, 6-f, 7-g, 8-h, 9-1.

The check column p for the columns s comprises, for each row z of the check column p, a sum of the values of the elements of the matrices 500 from the row z of the relevant matrix 500 and the column a.

This means that, in the error-free case, the sum of the scalar products that the vector forms with the values from the column s of the relevant matrix 500 for each column s must be the scalar product that the vector forms with the sums from the check column p.

The check column 10 of the check matrix 502 comprises, for each row z of the check column 10, a sum of the values of the elements of the check columns 1 from the matrices 500 from the row z.

This means that, in the error-free case, the sum of the scalar products that the vector forms with the values from the relevant check column 1 of the relevant matrix 500 must be the scalar product that the vector forms with the sums from the check column 10 of the matrix 502.

The third mapping rule allows error detection and localization. If the sum of the scalar products determined for a matrix 500 deviates from the scalar product determined for the check column 1 of the same matrix 500, an error in this matrix 500 is detected and localized.

If the sum of the scalar products determined for the columns s of the matrices 500 deviates from the scalar product determined for the check column p for the columns s, an erroneous scalar product is detected and localized in the column of the matrix 500 that has already been identified as erroneous. The scalar products determined for the other columns of the matrix 500, which was identified as erroneous, are identified as error-free and localized.

The third mapping rule also allows error correction in the matrix 500, which was identified as erroneous. In the example, the scalar product determined for the column identified as erroneous is corrected with a correction value.

In the example, the correction value is the sum of the scalar products determined for columns p of the matrices 500, minus the scalar products determined for columns p identified as error-free.

The mapping rule is not limited to the exemplary mapping rules. For other mapping rules, error detection and localization are executed as shown by way of example in the exemplary mapping rules.

The correction requires that the checksums used for the correction are determined based on exactly one common memory cell. For mapping rules that meet this condition, the correction is executed as described for the exemplary third mapping rule.

1-15. (canceled)

16. A computer-implemented method for localizing an error in a determination of matrix-vector products, wherein the matrix-vector products include scalar products, the method comprising the following steps:
for each respective matrix-vector product of the matrix-vector products, determining a respective first checksum to verify a respective first sum, wherein summands of the respective first sum are scalar products of the respective matrix-vector product;
determining a second checksum to verify a second sum, wherein summands of the second sum are one scalar product for each matrix-vector product; and
localizing the error in one of the scalar products depending on the respective first sums, the second sum, the respective first checksums, and the second checksum.

17. The method according to claim 16, wherein for each matrix-vector product, the first checksum is determined at least partially using in-memory computing.

18. The method according to claim 16, further comprising correcting the error, wherein a correction of the error in the scalar product in which the error is localized is determined depending on a difference between the respective first sum and the respective first checksum of the matrix-vector product including the scalar product in which the error is localized or depending on a difference between the second sum and the second checksum.

19. The method according to claim 18, wherein a plurality of second sums are formed, wherein summands of the second sums differ from each other by at least one summand, wherein a respective second checksum is determined for each respective second sum of the second sums to verify the respective second sum, wherein a third checksum is determined to verify a third sum, wherein summands of the third sum are: (i) the first checksums, (ii) the second checksums, or (iii) the first checksums and the second checksums, and wherein it is checked whether the third sum and the third checksum match, and wherein: (i) the correction of the error in the scalar product in which the error is localized is determined depending on the difference between the respective first sum and the respective first checksum of the matrix-vector product including the scalar product in which the error is localized, or a difference between a respective second sum and a respective second checksum corresponding to the second sum that includes the scalar product in which the error is localized, when the third sum and the third checksum match, and (ii) otherwise no correction of the error in the scalar product in which the error is localized is made depending on the difference between the respective first sum and the respective first checksum of the matrix-vector product including the scalar product in which the error is localized, or the difference between the respective second sum and the respective second checksum corresponding to the second sum that includes the scalar product in which the error is localized.

20. The method according to claim 16, wherein, for each respective matrix-vector product of the matrix-vector products, the respective matrix-vector product is determined depending on values of elements of a respective matrix, wherein the matrix-vector products are determined depending on values of elements of a vector.

21. The method according to claim 20, wherein values of elements of the respective matrix are each assigned to one of the scalar products, wherein, for each element of the vector, a sum of the values of the elements of the respective matrix, the values being multiplied in the scalar products by a value of the element of the vector, is determined, and a respective product of the sum of the values of the elements of the respective matrix with the value of the element of the vector is determined, wherein a sum of the respective products determined for the elements of the vector forms the first checksum.

22. The method according to claim 20, wherein, for each element of the vector, a sum of the values of the elements of the respective matrices, which, in the scalar products, form the summands of the second sum and which are multiplied by the value of the element of the vector, is determined, and a respective product of the sum of the values is determined with the value of the element of the vector, wherein a sum of the respective products forms the second checksum.

23. The method according to claim 20, wherein the values of the elements of the respective matrices and a sum of the values of the elements of each of the respective matrices are each stored as content of at least one memory cell of a memory according to a mapping rule, wherein, for each element of the vector, the mapping rule assigns, to the element of the vector, the memory cells whose content is to be multiplied by the element of the vector, wherein, for each scalar product, the mapping rule assigns, to the scalar product, the memory cells whose content is used to determine the scalar product, and wherein, for each checksum of the first checksum and the second checksum, the mapping rule assigns, to the checksum, the memory cells whose content is used to determine the checksum.

24. The method according to claim 23, wherein the values are read out from the contents of the memory cells for the calculation of the scalar products and checksums according to the mapping rule.

25. The method according to claim 24, wherein: (i) the values of the elements of the respective matrices are binary values and the memory cells each store one of the binary values, or (ii) the values of the elements of the respective matrices are multi-bit values and the memory cells each store one bit or a plurality of bits of a multi-bit value according to the mapping rule, wherein the multi-bit values are read out from the memory cells according to the mapping rule.

26. The method according to claim 23, wherein the values are stored in analog memory cells, or the values are stored in digital memory cells.

27. A device for localizing an error in a determination of matrix-vector products to correct the error, wherein the matrix-vector products include scalar products, wherein the device is configured to perform the following steps:
for each respective matrix-vector product of the matrix-vector products, determining a respective first checksum to verify a respective first sum, wherein summands of the respective first sum are scalar products of the respective matrix-vector product;
determining a second checksum to verify a second sum, wherein summands of the second sum are one scalar product for each matrix-vector product; and
localizing the error in one of the scalar products depending on the respective first sums, the second sum, the respective first checksums, and the second checksum.

28. The device according to claim 27, wherein the device comprises a memory which has analog memory cells or digital memory cells.

29. The device according to claim 28, wherein the device comprises, for each scalar product of the scalar products, an adder or at least one output to an adder which is configured to determine the scalar product, wherein the device further comprises, for each checksum of the first checksum and the second checksum, an adder or at least one output to an adder which is configured to determine the checksum.

30. The device according to claim 29, wherein the device comprises at least one processor, wherein the device is configured to determine a portion of the scalar products and/or a portion of the summands of the respective first sums and/or the second sum, in the memory, and another portion of the scalar products and/or another portion of the summands of the respective first sums and/or the second sum, using the at least one processor, and to determine:
(i) the respective first sums and the second sum and/or (ii) the respective first checksums and the second checksum, using the at least one processor or the adders, or partially using the at least one processor and partially using the adders.

31. A non-transitory computer-readable medium on which is stored a computer program including computer-readable instructions for localizing an error in a determination of matrix-vector products, wherein the matrix-vector products include scalar products, the instructions, when executed by a computer, causing the computer to perform the following steps:
for each respective matrix-vector product of the matrix-vector products, determining a respective first checksum to verify a respective first sum, wherein summands of the respective first sum are scalar products of the respective matrix-vector product;
determining a second checksum to verify a second sum, wherein summands of the second sum are one scalar product for each matrix-vector product; and
localizing the error in one of the scalar products depending on the respective first sums, the second sum, the respective first checksums, and the second checksum.
